(19) United States
(12) Patent Application Publication
(10) Pub. No.: US 2025/0190959 A1
(43) Pub. Date: Jun. 12, 2025

(54) Real-Time NIL Payments to College Athletes During Athletic Events

(71) Applicant: William C. Busch, Lincoln, NE (US)

(72) Inventor: William C. Busch, Lincoln, NE (US)

(21) Appl. No.: 18/977,244

(22) Filed: Dec. 11, 2024

Related U.S. Application Data
(60) Provisional application No. 63/608,708, filed on Dec. 11, 2023.

(51) Int. Cl. G06Q 20/10

(52) U.S. Cl. CPC G06Q 20/10

(57) ABSTRACT

A real-time NIL payment system that allows fans to make NIL payments during a game or other collegiate sporting event which would go directly to a particular college athlete for an athletic achievement on the field.

### CROSS-REFERENCE TO RELATED APPLICATIONS

The present application claims priority from, and incorporates by reference in its entirety, U.S. provisional patent application 63/608,708 filed Dec. 11, 2023.

### BACKGROUND

### Field of the Invention

Various embodiments of the present invention relate to payments for athletes, and in particular, to name, image and likeness (NIL) payments for college athletes during an athletic event.

### Description of Related Art

In 2019 California, Alabama, Georgia, Florida and a number of other states began passing laws allowing college athletes to be paid for use of their name, image and likeness (NIL). The leadership of the National Collegiate Athletic Association (NCAA) initially agreed to implement rules defining a system for NIL payments to collegiate athletes by January 2021. The NCAA later backed off its effort to implement NIL payments, citing antitrust concerns.

The U.S. Supreme Court case Alston vs. NCAA, unanimously decided on Jun. 21, 2021, prohibited the NCAA from limiting education-related benefits to athletes. Meanwhile, more and more states passed laws allowing for NIL payments to college athletes. Most of the state NIL laws were set to become effective just prior to the 2021 season. Finally, on Jun. 30, 2021, just prior to many of the state NIL laws taking effect, the NCAA announced an interim NIL policy that allowed NCAA athletes to be paid for their name, image and likeness.

Today, nearly all large collegiate athletic programs have systems in place to make regularly scheduled NIL payments to their athletes. Many thousands of college athletes now receive monetary payments from NIL programs aligned with their school or have signed commercial endorsement deals which provide for NIL payments. The NIL payments made as part of these conventional NIL programs are regularly scheduled and negotiated with the student athlete ahead of time.

### BRIEF SUMMARY

The present inventor recognized a need for fans to be able to make NIL payments which would go directly to a particular athlete for an athletic achievement during a game or other event relating to athletics. The various embodiments achieve this objective, and others, as discussed in the paragraphs below and illustrated in the drawings.

### DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1 is a flowchart of a method of practicing various embodiments.

FIG. 2A depicts an example of an athletic achievement likely to result in real-time NIL payments, according to various embodiments.

FIG. 2B depicts a stadium scoreboard showing real-time NIL payments, according to various embodiments.

### DETAILED DESCRIPTION

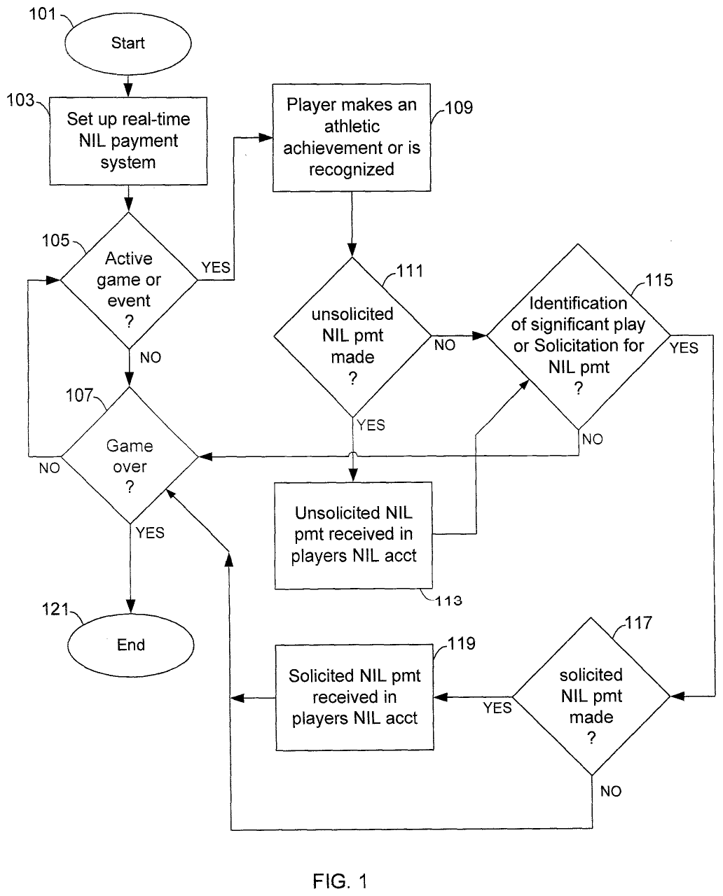

FIG. 1 is a flowchart of a method of practicing various embodiments of the invention. The method begins at block 101 and proceeds to block 103 where a real-time NIL payment program is set up at a university (or college) with college athletes eligible to receive NIL payments. The real-time NIL payment program could be called something like, “Big Screen NIL Bonus Bucks,” or other such descriptive name. The real-time NIL payment program may be set up by the university, or may be set up by one or more NIL collectives—that is, organizations associated with a university, but not necessarily part of the university, that handle the collection, administration and dispersion of NIL money. For example, The 1890 Initiative and The Big Red Collaborative are two NIL collectives associated with the University of Nebraska athletics. Setting up the real-time NIL payment system may include the following activities:
Setting up NIL accounts for all the athletes participating in the real-time NIL payment system.
Setting up fan accounts for fans who plan to attend an athletic event and may want to make a real-time NIL payment.
Setting up one or more real-time payment methods for fans to use, e.g., Venmo, Google Pay, Apple Pay, Cash App, Zelle, ACH cash transfer, etc.
Coordinating with the announcers and staff controlling replay devices.
Ensuring compliance with NCAA regulations and any state or federal laws that may apply.

Once the real-time NIL payment system is set up the method proceeds to block 105 to determine whether a game or event is currently active. The game could be a game of football, volleyball, basketball, baseball, wrestling, track and field, lacrosse, bowling, or any of dozens of sports played by collegiate athletes. The event could be any of the types of games described above, or could be another type of event involving college athletes such as a booster event or awards recognition ceremony. For the sake of brevity the embodiments will be described in terms of a game being played.

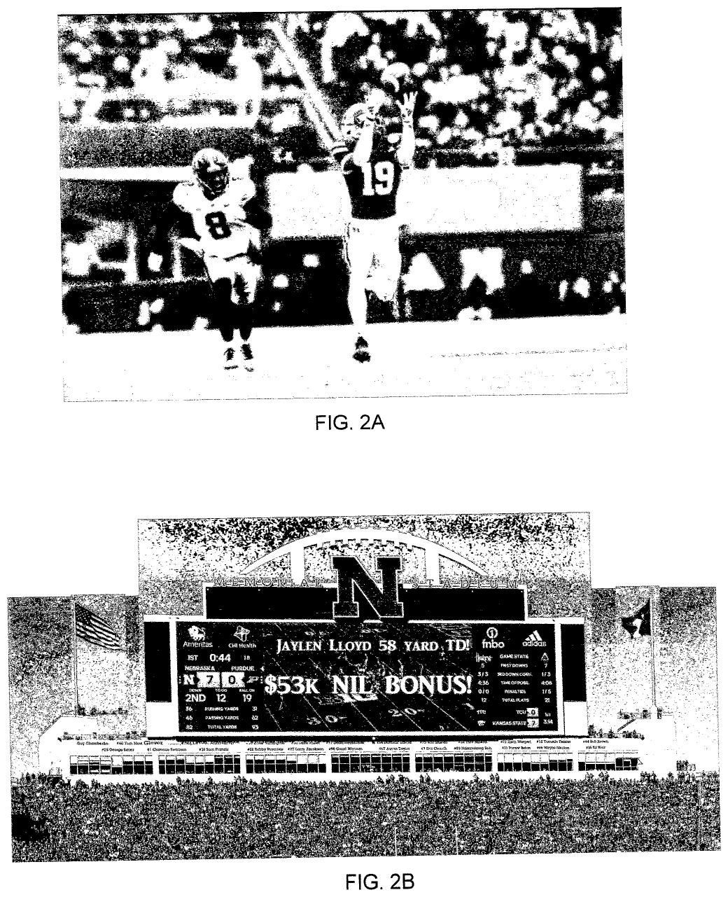

If the game is currently being played the method proceeds to block 109 along the YES path. In block 109 the player makes an athletic achievement or is otherwise recognized for his or her contributions. The athletic event could be something dramatic-like a quarterback throwing a hail-Mary touchdown on the last play to win a game, or a fan-favorite defensive tackle blocking a field goal. FIG. 2A depicts Nebraska football player Jalen Lloyd making a reception that resulted in a 58-yard touchdown against rival Iowa in 2023. FIG. 2B depicts what the scoreboard might look like following Jalen Lloyd's 58-yard touchdown reception. The athletic event could also be something less dramatic to most fans, but important to the athlete-like a true freshman rush end making the first tackle of his career in a football game. If the event is something other than a game, block 109 could entail something like recognition for athletic performance at an awards banquet or booster event.

The method proceeds from block 109 to 111 where it is determined whether fans—or a fan—has made an unsolicited NIL payment. It may be the case that a given fan has decided to make an NIL contribution to a player for reasons other than on-the-field performance or recognition at a booster event. For example, perhaps a banker from Pender, Nebraska is at a football in Nebraska's Memorial Stadium. He may decide to make an NIL contribution to a freshman walk-on player who has not been in on a single play, but is also from Pender Nebraska. In some embodiments the real-time NIL payment program may be set up so that payments go directly to the student athlete's account. In other embodiments the payment may go to a collective that, in turn, distributes it to the student. The distribution to the student may, in some implementations, be in real-time so the student athlete's account receives the payment from the collective while the game is still being played. If it is determined in block 111 that one or more fans decide to make an unsolicited NIL payment the method proceeds to block 113 where the payment is made. The payment may be made by any of several apps for making real-time payments, e.g., Venmo, Google Pay, Apple Pay, Cash App, Zelle, ACH cash transfer, or other like types of real-time payment methods. Alternatively, the real-time NIL payment system may allow fans to set up an account for themselves and fund their accounts ahead of time. That way, the NIL payment would simply be transferred from the fan's account to the student's NIL account.

Once the NIL payment has been made in block 113 the method proceeds to block 115 where it is determined whether a significant athletic achievement has been identified and solicitation has been made for making an NIL payment to a given player. This may occur, for example, following a tremendous play with significant potential to affect the outcome of the game. Significant plays are often shown on replay—that is, on replays during the television broadcast and also on replays on the large video displays in the stadium. During the replay—either television or live at the stadium—the announcer may point out the tremendous performance, and could even suggest that such a play is worthy of an NIL reward—a solicitation of an NIL donation. Such a comment is considered for purposes herein to be an NIL solicitation which is likely to result in a number of NIL donations to the student athlete. If it is determined in block 115 that no NIL payment solicitation was made the method loops back around to block 107 via the NO path. However, if block 115 determines that an NIL payment solicitation was made the method proceeds to block 117 via the YES path.

Block 117 of the method determines whether one or more NIL payments have been made in response to the solicitation for NIL payments of block 115. If NIL payment(s) have been made the method proceeds from block 117 to block 119 via the YES branch. In block 119 the NIL payment is received in the student athlete's NIL account. Upon receiving the NIL payment the method proceeds from block 119, looping back to block 107 and the method starts all over again.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes,” and/or “including” used in this specification specify the presence of stated features, integers, steps, operations, elements, and/or components, but do not preclude the presence or addition of one or more other features, integers, steps, operations, elements, components, and/or groups thereof. The term “plurality”, as used herein and in the claims, means two or more of a named element. It should not, however, be interpreted to necessarily refer to every instance of the named element in the entire device. Particularly, if there is a reference to “each” element of a “plurality” of elements. There may be additional elements in the entire device that are not be included in the “plurality” and are not, therefore, referred to by “each.”

The description of the various embodiments provided above is illustrative in nature inasmuch as it is not intended to limit the invention, its application, or uses. Thus, variations that do not depart from the intents or purposes of the invention are intended to be encompassed by the various embodiments of the present invention. Such variations are not to be regarded as a departure from the intended scope of the present invention.

What is claimed is:

1. A method of making an NIL payment comprising:
setting up a real-time NIL payment system;
creating a plurality of fan accounts respectively associated with a plurality of fans in the real-time NIL payment system;
creating a plurality of player NIL accounts in the real-time NIL payment system, the plurality of player NIL accounts including a first NIL account associated with a first player;
recognizing a significant athletic achievement by the first player during a collegiate athletic event;
receiving a real-time NIL payment from a fan among the plurality of fans significant athletic achievement; and
depositing the real-time NIL payment in the first NIL account associated with the first player.
